(19) United States
(12) Patent Application Publication
(10) Pub. No.: US 2016/0261119 A1
(43) Pub. Date: Sep. 8, 2016

(54) POWER ADAPTER, POWER ADAPTING SYSTEM AND METHOD THEREOF

(71) Applicant: Canyon Semiconductor Inc., Hsinchu (TW)

(72) Inventor: PO-YUAN YU, TAOYUAN CITY (TW)

(21) Appl. No.: 14/743,300

(22) Filed: Jun. 18, 2015

(30) Foreign Application Priority Data
Mar. 2, 2015 (TW) 104106464

(51) Int. Cl. H02J 4/00

(52) U.S. Cl. CPC H02J 4/00

(57) ABSTRACT

A power adapter includes: one or more first voltage output ports, arranged to provide a first voltage level; and one or more second voltage output ports, arranged to receive a first communication protocol, and accordingly provide a second voltage level according to the first communication protocol.

### TECHNICAL FIELD

The present disclosure relates to a power adapter, a power adapting system and a method thereof.

### DISCUSSION OF THE BACKGROUND

With the evolution of technology, electronic devices having different kinds of function are developed. Those electronic devices may be configured to have their own power supply standards. A power adapter is developed to provide a required power to an electronic device according to a supply power. However, when all electronic devices have their own power adapters, it may cause a great inconvenience for a user. To solve this problem, a conventional power adapter capable of generating a plurality of predetermined output powers by referring to a supply power is developed for the electronic devices. However, those predetermined output powers are not adjustable. If an electronic device with a required power that is excluded from the predetermined output powers is plugged into the conventional power adaptor, the electronic device will not be powered up by the output power, and the output power may even destroy the electronic device.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

A novel power adapter is provided to solve the above problem.

According to a first embodiment, a power adapter is disclosed. The power adapter comprises one or more first voltage output ports and one or more second voltage output ports. The first voltage output port is arranged to provide a first voltage level. The second voltage output port is arranged to receive a first communication protocol, and accordingly provide a second voltage level according to the first communication protocol.

According to a second embodiment, a power adapting system is disclosed. The power adapting system comprises an external device and a power adapter. The power adapter comprises one or more first voltage output ports and one or more second voltage output ports. The first voltage output port is arranged for providing a first voltage level. The second voltage output port is coupled to the external device for receiving a first communication protocol, and providing a second voltage level to the external device according to the first communication protocol.

According to a third embodiment, a power adapting method is provided. The power adapting method comprises: providing a first voltage level to one or more first voltage output ports; receiving a first communication protocol via one or more second voltage output ports; and providing a second voltage level on the second voltage output port according to the first communication protocol.

The foregoing outlines features of several embodiments so that those skilled in the art may better understand the aspects of the present disclosure. Other technical features and advantages constituting claims of the present disclosure are described in the following descriptions. Those skilled in the art should appreciate that they may readily use the present disclosure as a basis for designing or modifying other processes and structures for carrying out the same purposes of the embodiments introduced herein. Those skilled in the art should also realize that such equivalent constructions do not depart from the spirit and scope of the present disclosure, and that they may make various changes, substitutions.

### BRIEF DESCRIPTION OF THE DRAWINGS

Aspects of the present disclosure are best understood from the following detailed description when read with the accompanying figures. Please note that in accordance with the standard practice in the industry, various features are not drawn to scale. In fact, the dimensions of the various features may be arbitrarily increased or reduced for clarity of discussion.

FIG. 1 is a diagram illustrating a power adapter according to an embodiment of the present invention.

FIG. 2 is a diagram illustrating a power adapting system according to an embodiment of the present invention.

FIG. 3 is a flowchart illustrating a power adapting method according to an embodiment of the present invention.

### DETAILED DESCRIPTION

In order for one with ordinary skill in the art to thoroughly understand the present disclosure, the following descriptions provide detailed steps and structures. Obviously, the implementation of the present disclosure is not limited to the specific details known by one with common knowledge in the art. On the other hand, well-known structures or steps are not described in the details of the description, so as to avoid unnecessary limitations to the present disclosure. Preferred embodiments of the present disclosure are described in detail as follows; however, in addition to these detailed descriptions, the present disclosure can also be widely applied in other embodiments. The scope of the present disclosure is not limited to the descriptions of embodiments, but is defined in the claims.

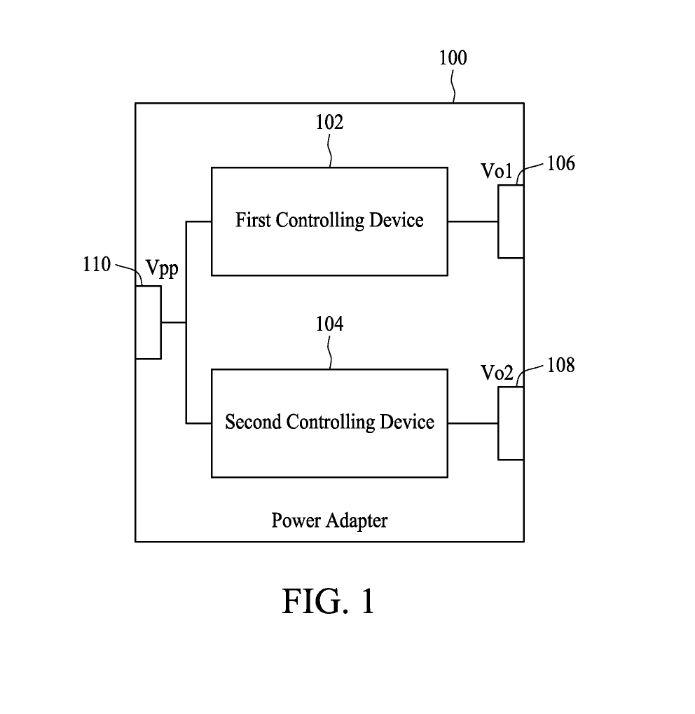

FIG. 1 is a diagram illustrating a power adapter 100 according to an embodiment of the present invention. In this embodiment, the power adapter 100 comprises a first controlling device 102, a second controlling device 104, one or more first voltage output ports 106, one or more second voltage output ports 108, and a third voltage receiving port 110. A terminal of the first controlling device 102 is coupled to the first voltage output port 106, and an additional terminal of the first controlling device 102 is coupled to the third voltage receiving port 110 for receiving a power supply voltage Vpp. A terminal of the second controlling device 104 is coupled to the second voltage output port 108, and an additional terminal of the second controlling device 104 is coupled to the third voltage receiving port 110 for receiving the power supply voltage Vpp. In this embodiment, the first controlling device 102 is arranged to control the first voltage output port 106 for providing a first voltage level Vo1, and the second controlling device 104 receives a first communication protocol Shs1 via the second voltage output port 108, and the second controlling device 104 controls the second voltage output port 108 to generate a second voltage level Vo2 according to the first communication protocol Shs1 and the power supply voltage Vpp. Please note that the term “communication protocol” in this embodiment may be regarded as the communication protocol signal.

In one embodiment, the first voltage level Vo1 on the first voltage output port 106 is a predetermined or fixed voltage level, and the second voltage level Vo2 on the second voltage output port 108 can be any voltages within a voltage level range Vr. The second controlling device 104 performs a handshaking operation to determine the second voltage level Vo2. Specifically, the second controlling device 104 receives the first communication protocol Shs1 via the second voltage output port 108 to perform the handshaking operation. In other words, the first voltage output port 106 of the power adapter 100 is configured to provide a fixed voltage level on the first voltage output port 106, and the second voltage output port 108 is configured to provide an adaptive voltage level on the second voltage output port 108. Therefore, the first voltage output port 106 and the second voltage output port 108 are capable of generating the first voltage level Vo1 and the second voltage level Vo2 substantially at the same time or at different times, respectively.

In the embodiment, the first voltage output port 106, the second voltage output port 108, and the third voltage receiving port 110 can be any kind of connection ports, such as signal or power ports and/or output/input ports. In addition, the first voltage output port 106, the second voltage output port 108, and the third voltage receiving port 110 may each comprise more than one different or same ports.

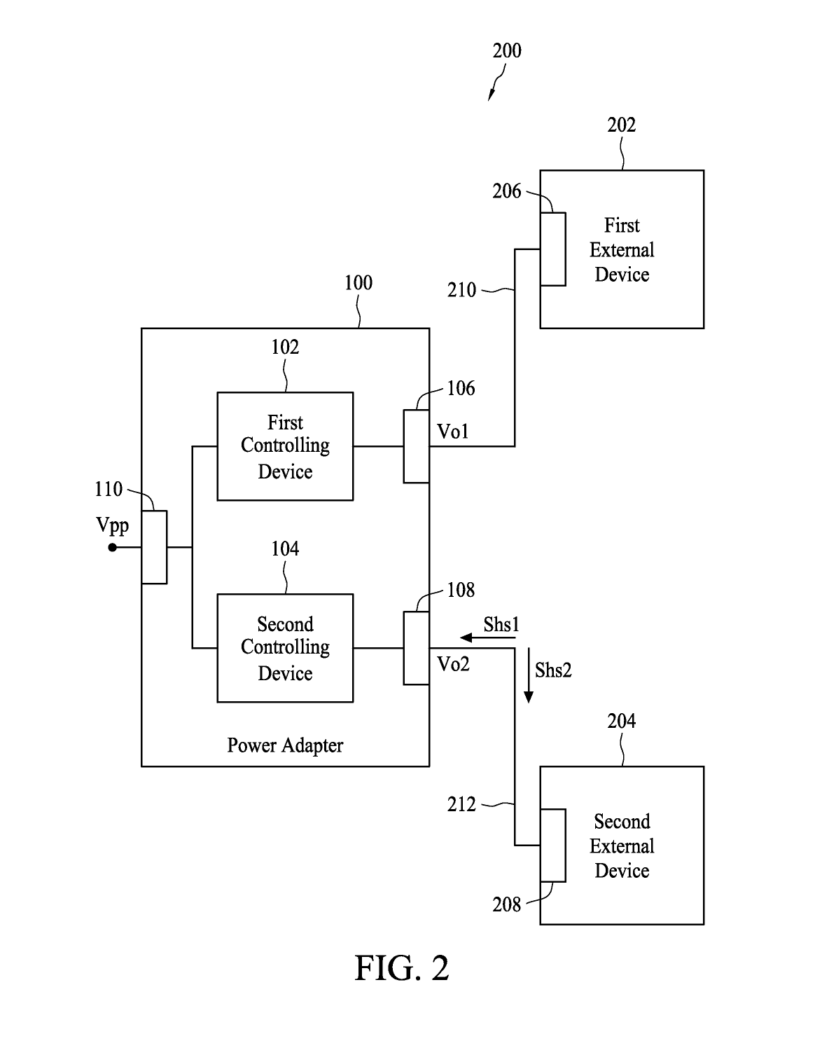

FIG. 2 illustrates the operation of the power adapter 100. FIG. 2 is a diagram illustrating a power adapting system 200 according to an embodiment of the present invention. The power adapting system 200 comprises the power adapter 100, a first external device 202, and a second external device 204. A power input port 206 of the first external device 202 is coupled to the first voltage output port 106 of the power adapter 100 via a transmission line 210, and a power input port 208 of the second external device 204 is coupled to the second voltage output port 108 of the power adapter 100 via a transmission line 212. The third voltage receiving port 110 of the power adapter 100 is coupled to the power supply voltage Vpp. Please note that the transmission lines 210, 212 can be any kind of transmission lines or connection lines as long as the transmission lines or connection lines can transmit power.

In the embodiment, the acceptable power supply voltage of the first external device 202 is substantially the first voltage level Vo1, and the acceptable power supply voltage of the second external device 204 is substantially the second voltage level Vo2, wherein the second voltage level Vo2 is different from the first voltage level Vo1, and the second voltage level Vo2 falls within the voltage level range Vr. As the first controlling device 102 of the power adapter 100 refers the power supply voltage Vpp for outputting the first voltage level Vo1 on the first voltage output port 106, the first external device 202 can directly receive the first voltage level Vo1 via the transmission line 210. However, regarding the second external device 204, the second voltage level Vo2 of the second external device 204 is different from the first voltage level Vo1. Thus, the second external device 204 cannot directly couple to the first voltage output port 106. As the second voltage level Vo2 falls within the voltage level range Vr, the second external device 204 can be coupled to the second voltage output port 108. Then, the second controlling device 104 performs a handshaking operation to output the second voltage level Vo2 for the second external device 204.

In one embodiment, when the second external device 204 performs the handshaking operation with the second controlling device 104, the second external device 204 transmits the first communication protocol Shs1 to the second controlling device 104 via the transmission line 212 and the second voltage output port 108. The first communication protocol Shs1 may comprise the information of the second voltage level Vo2 required by the second external device 204. When the second controlling device 104 receives the first communication protocol Shs1, the second controlling device 104 may transmits a second communication protocol Shs2 to the second external device 204 to inform the second external device 204 if the second controlling device 104 has the capability to generate the second voltage level Vo2. Similarly, the second communication protocol Shs2 is transmitted to the second external device 204 via the transmission line 212 and the second voltage output port 108. If the second voltage level Vo2 falls within the voltage level range Vr, meaning that the second controlling device 104 can generate the second voltage level Vo2, then the second controlling device 104 generates the second voltage level Vo2 on the second voltage output port 108 according to the power supply voltage Vpp. Accordingly, when the handshaking operation is finished, the second external device 204 can receive the required second voltage level Vo2 from the second voltage output port 108. On the other hand, if the second voltage level Vo2 does not fall within the voltage level range Vr, the second controlling device 104 cannot output the required voltage or power on the second voltage output port 108. It is noted that the above mentioned handshaking operation is a simplified handshaking operation. The embodiment is not limited to the simplified handshaking operation. In other words, the above mentioned first communication protocol Shs1 may further comprise a plurality of signals generated by the second external device 204, and the second communication protocol Shs2 may also comprise a plurality of signals generated by the second controlling device 104. The plurality of signals may be transmitted or have a handshake performed between the second controlling device 104 and the second external device 204 via the second voltage output port 108. Those operations also fall within the scope of the present invention.

In addition, in this embodiment, the first controlling device 102 and the second controlling device 104 are two independent controlling devices. Therefore, the first controlling device 102 and the second controlling device 104 are capable of generating the first voltage level Vo1 and the second voltage level Vo2 at the same time, respectively. However, this is not a limitation of the present invention. In another embodiment, the first controlling device 102 and second controlling device 104 may also be integrated into a single controlling device for generating the first voltage level Vo1 and the second voltage level Vo2 at the same time, which also falls within the scope of the present invention.

Moreover, even though the first controlling device 102 and the second controlling device 104 generate the first voltage level Vo1 and the second voltage level Vo2 according to the power supply voltage Vpp respectively, the first voltage level Vo1 and the second voltage level Vo2 are not necessary lower than the power supply voltage Vpp. The first voltage level Vo1 and the second voltage level Vo2 may be higher or lower than the power supply voltage Vpp. In other words, the voltage level range Vr that can be generated by the second controlling device 104 may be a voltage range lower than the power supply voltage Vpp, a voltage range higher than the power supply voltage Vpp, or a voltage range including the power supply voltage Vpp.

In addition, in the practical operation of the device, when the first controlling device 102 and the second controlling device 104 output the first voltage level Vo1 and the second voltage level Vo2 to the first external device 202 and the second external device 204 via the first voltage output port 106 and the second voltage output port 108 respectively, the first controlling device 102 and the second controlling device 104 may also output the required currents to the first external device 202 and the second external device 204 via the first voltage output port 106 and the second voltage output port 108, respectively. In other words, the first controlling device 102 and the second controlling device 104 may provide the required powers to the first external device 202 and the second external device 204 via the first voltage output port 106 and the second voltage output port 108, respectively.

Please note that the present power adapter 100 is not limited to the above configuration, i.e. the first controlling device 102 in combination with the first voltage output port 106 which generates the first voltage level Vo1 and the second controlling device 104 in combination with the second voltage output port 108 which generates the second voltage level Vo2. The power adapter 100 in FIG. 1 is simply an exemplary embodiment for describing the feature of the present invention. In another embodiment of the power adapter, only the circuit combination of the second controlling device 104 and second voltage output port 108 is used to generate the second voltage level Vo2, which also belongs to the scope of the present invention. Furthermore, in another embodiment of the power adapter, there may comprise a plurality of a first set of circuit combinations (i.e. the first controlling device 102 and the first voltage output port 106) and a plurality of a second set of circuit combinations (i.e. the second controlling device 104 and the second voltage output port 108) for providing a plurality of fixed power supply voltages and a plurality of handshake power supply voltages to a plurality of external devices, respectively, which also belongs to the scope of the present invention.

According to the operation of the power adapter 100, once the power supply voltage of an external device falls within the voltage level range Vr, and the external device has the ability of performing a handshaking operation, then the external device can perform the handshaking operation to obtain the required power supply voltage via a power line coupled to the second voltage output port 108 of the power adapter 100. In other words, the power adapter 100 is capable of adaptively providing power to the external devices having different power supply voltage requirements. Therefore, the present power adapter 100 can replace most power adapters with fixed output powers. Furthermore, when an electronic device plugs into the present power adapter 100, the power adapter 100 does not damage the electronic device, even if the required power supply is not within the voltage level range Vr.

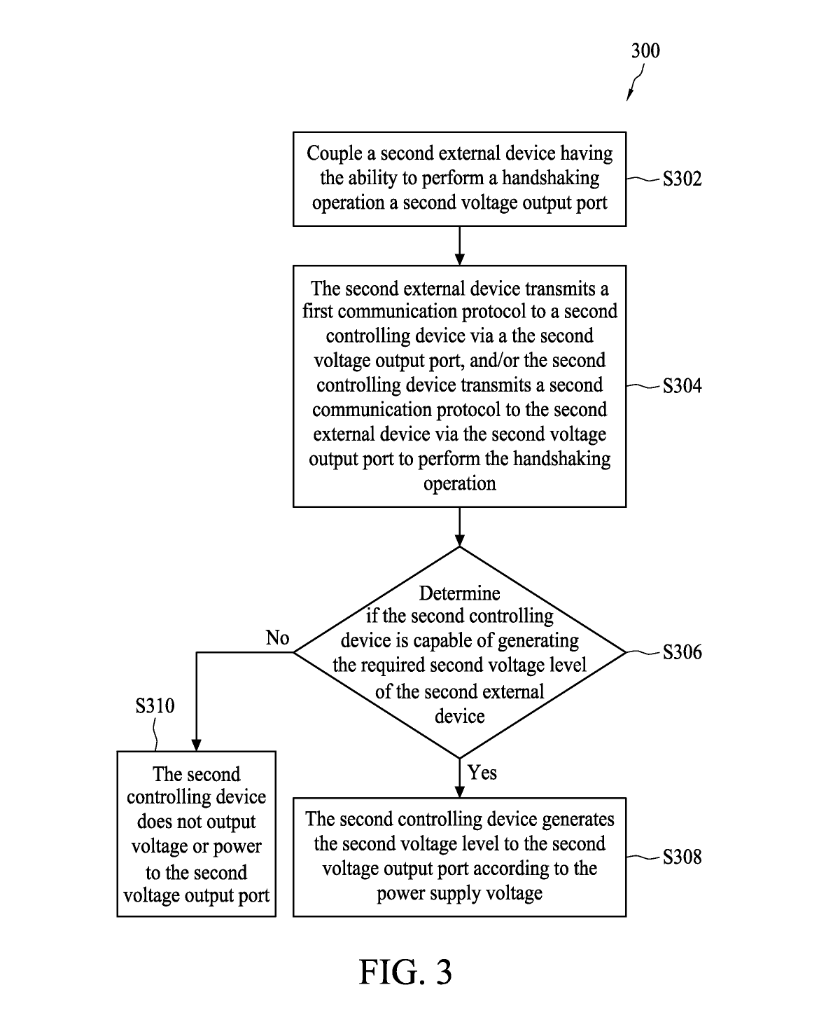

Briefly, the operation of the power adapter 100 can be illustrated as the power adapting method as shown in FIG. 3. FIG. 3 is a flowchart illustrating a power adapting method 300 according to an embodiment of the present invention. In step S302 of FIG. 3, the second external device 204, having the ability to perform the handshaking operation, is coupled to the second voltage output port 108 via the transmission line 212.

In step S304, the second external device 204 transmits the first communication protocol Shs1 to the second controlling device 104 via the transmission line 212 and the second voltage output port 108, and/or the second controlling device 104 transmits the second communication protocol Shs2 to the second external device 204 via the transmission line 212 and the second voltage output port 108 to perform the handshaking operation.

In step S306, it is determined if the second controlling device 104 is capable of generating the required second voltage level Vo2 of the second external device 204. If the second controlling device 104 is capable of generating the required second voltage level Vo2 of the second external device 204, the method goes to step S308. In step S308, the second controlling device 104 generates the second voltage level Vo2 to the second voltage output port 108 according to the power supply voltage Vpp.

If the second controlling device 104 is not able to generate the required second voltage level Vo2 of the second external device 204, the method goes to step S310. In step S310, the second controlling device 104 does not output voltage or power to the second voltage output port 108. In short, if the second voltage level Vo2 falls within the voltage level range Vr, then the second controlling device 104 generates the second voltage level Vo2 on the second voltage output port 108 according to the power supply voltage Vpp. If the second voltage level Vo2 is not within the voltage level range Vr, the second controlling device 104 does not output the voltage or power to the second voltage output port 108.

Although the technical content and technical features of the present disclosure are disclosed in the above descriptions, one with ordinary skill in the art would understand substitutions and modifications may be made without departing from the spirit and scope of claims of the present disclosure. For example, many of the above disclosed processing procedures can be substituted by different implementations, other procedures or a combination of any two of the above disclosed processing procedures.

Additionally, the scope of claims of the present application is not limited to the procedures, machines, manufacture, components of matters, devices, methods or steps disclosed in the above embodiments. One with ordinary knowledge in the art of the present disclosure would understand that based on the present disclosure, the current or future developed procedures, machines, manufacture, components of matters, devices, methods or steps, which implement substantially the same functions and achieve substantially the same effects as those of the present disclosure, can be used in the present disclosure. Hence, these procedures, machines, manufacture, components of matters, devices, methods and steps fall within the scope of the following claims.

What is claimed is:

1. A power adapter, comprising:
one or more first voltage output ports, arranged to provide a first voltage level; and
one or more second voltage output ports, arranged to receive a first communication protocol, and accordingly provide a second voltage level according to the first communication protocol.

2. The power adapter of claim 1, wherein the first voltage level is a predetermined voltage level, and the second voltage level is any voltages within a voltage level range.

3. The power adapter of claim 1, wherein the first voltage output port and the second voltage output port provide the first voltage level and the second voltage level respectively at the same time.

4. The power adapter of claim 1, further comprising:
a first controlling device, coupled to the first voltage output port, for receiving a power supply voltage; and
a second controlling device, coupled to the second voltage output port, for receiving the power supply voltage;
wherein the first controlling device is arranged to control the first voltage output port for providing the first voltage level, and the second controlling device receives the first communication protocol via the second voltage output port, and controls the second voltage output port to generate the second voltage level according to the first communication protocol and the power supply voltage.

5. The power adapter of claim 4, wherein the second voltage output port is coupled to an external device for receiving the first communication protocol.

6. The power adapter of claim 5, wherein the second controlling device is arranged to receive the first communication protocol via the second voltage output port, and perform a handshaking operation with the external device via the second voltage output port to determine the second voltage level.

7. The power adapter of claim 6, wherein the second controlling device further outputs a second communication protocol to the external device via the second voltage output port for performing the handshaking operation to determine the second voltage level.

8. A power adapting system, comprising:
an external device; and
a power adapter, comprising:
one or more first voltage output ports, for providing a first voltage level; and
one or more second voltage output ports, coupled to the external device, for receiving a first communication protocol, and providing a second voltage level to the external device according to the first communication protocol.

9. The power adapting system of claim 8, wherein the first voltage level is a predetermined voltage level, and the second voltage level is any voltages within a voltage level range.

10. The power adapting system of claim 8, wherein the first voltage output port and the second voltage output port provide the first voltage level and the second voltage level respectively at the same time.

11. The power adapting system of claim 8, wherein the power adapter further comprises:
a first controlling device, coupled to the first voltage output port, for receiving a power supply voltage; and
a second controlling device, coupled to the second voltage output port, for receiving the power supply voltage;
wherein the first controlling device is arranged to control the first voltage output port for providing the first voltage level, and the second controlling device receives the first communication protocol via the second voltage output port, and controls the second voltage output port to generate the second voltage level according to the first communication protocol and the power supply voltage.

12. The power adapting system of claim 11, wherein the external device is arranged to generate the first communication protocol.

13. The power adapting system of claim 12, wherein the second controlling device is arranged to receive the first communication protocol via the second voltage output port, and perform a handshaking operation with the external device via the second voltage output port to determine the second voltage level.

14. The power adapting system of claim 13, wherein the second controlling device further outputs a second communication protocol to the external device via the second voltage output port for performing the handshaking operation to determine the second voltage level.

15. A power adapting method, comprising:
(a) providing a first voltage level to one or more first voltage output ports;
(b) receiving a first communication protocol via one or more second voltage output ports; and
(c) providing a second voltage level on the second voltage output port according to the first communication protocol.

16. The power adapting method of claim 15, wherein the first voltage level is a predetermined voltage level, and the second voltage level is any voltages within a voltage level range.

17. The power adapting method of claim 15, wherein the step (a) comprises:
controlling the first voltage output port to provide the first voltage level according to a power supply voltage; and
the step (c) comprises:
controlling the second voltage output port to generate the second voltage level according to the first communication protocol and the power supply voltage.

18. The power adapting method of claim 17, wherein the step (b) comprises:
receiving the first communication protocol via the second voltage output port coupled to an external device.

19. The power adapting method of claim 18, wherein the step (c) comprises:
performing a handshaking operation with the external device via the second voltage output port to determine the second voltage level according to the first communication protocol.
